(19) United States
(12) Patent Application Publication
(10) Pub. No.: US 2015/0264334 A1
(43) Pub. Date: Sep. 17, 2015

(54) PARALLAX IMAGE GENERATION DEVICE

(71) Applicant: KABUSHIKI KAISHA TOSHIBA, Tokyo (JP)

(72) Inventors: Soichiro HOSODA, Kawasaki Kanagawa (JP); Takuma YAMAMOTO, Yokohama Kanagawa (JP)

(21) Appl. No.: 14/474,303

(22) Filed: Sep. 2, 2014

(30) Foreign Application Priority Data
Mar. 13, 2014 (JP) 2014-050875

(51) Int. Cl. H04N 13/02; G06K 9/46

(52) U.S. Cl. CPC H04N 13/0225; G06K 9/4604

(57) ABSTRACT

A parallax image generation device generates motion vectors of a first image with respect to a second image, the first image including a blank region that does not contain any image information and an effective region that contains image information. The parallax image generation device includes a motion vector search circuit configured to generate motion vectors of blocks of the effective region and blocks of the blank region, at least one of the blocks of the blank region being generated from a motion vector of a block of the effective region, and an output control circuit connected to the motion vector search circuit and configured to output the motion vectors of the blocks of the effective region and the blank region that have been generated by the motion vector search circuit in a raster scan order.

### CROSS-REFERENCE TO RELATED APPLICATION

This application is based upon and claims the benefit of priority from Japanese Patent Application No. 2014-050875, filed Mar. 13, 2014, the entire contents of which are incorporated herein by reference.

### FIELD

Embodiments described herein relate generally to a parallax image generation device.

### BACKGROUND

One type of computational camera is a multi-view camera that generates a parallax image, based on input images from multiple cameras. In the input images from the multiple cameras a pixel gap, an angular misalignment, a distortion, and the like between the input images may occur, in addition to parallax in an ideal state. This results from positional deviation (axial deviation that occurs when lenses are mounted) between lenses in the cameras. In order to resolve the pixel gap and the like between the input images that result from the deviation when the lenses are mounted, image processing (for example, affine processing) such as rotating or shifting of the input image is performed. If the input images are compared after the image processing that entails the rotating or shifting of the input image, a blank region in which a pixel value is not present may occur at a screen edge.

### DESCRIPTION OF THE DRAWINGS

FIG. 1 is a block diagram illustrating an outline configuration of a parallax image generation device according to a first embodiment.

FIG. 2 is a diagram for describing information that is input into an input interface.

FIG. 3 is a diagram for describing in detail a processing operation by a filter circuit.

FIGS. 4A and 4B are diagrams for describing in detail a processing operation that is performed by a motion vector search circuit when a macro block is not in contact with a blank region.

FIG. 5 is a diagram for describing in detail the processing operation that is performed by the motion vector search circuit when the macro block is not in contact with a blank region.

FIG. 6 is a diagram for describing in detail the processing operation that is performed by the motion vector search circuit when the macro block is not in contact with a blank region.

FIGS. 7A and 7B are diagrams for describing in detail a processing operation that is performed by the motion vector search circuit when a target macro block is in contact with a blank region.

FIGS. 8A and 8B are diagrams for describing in detail a processing operation that is performed by the motion vector search circuit when a target macro block resides in a blank region.

FIGS. 9A to 9E are diagrams illustrating configuration examples of a buffer in an output control circuit.

FIG. 10 is a block diagram illustrating an outline configuration of a parallax image generation device according to a second embodiment.

FIGS. 11(A) to (C) are diagrams for describing timing of processing by the parallax image generation device in FIG. 10.

FIG. 12 is a schematic diagram of a sub-image that results when a blank region is oblique.

### DETAILED DESCRIPTION

Embodiments provide a parallax image generation device that is capable of generating a parallax image even though an input image includes a blank region.

In general, according to one embodiment, there is provided a parallax image generation device that generates motion vectors of a first image with respect to a second image, the first image including a blank region that does not contain any image information and an effective region that contains image information. The parallax image generation device includes a motion vector search circuit configured to generate motion vectors of blocks of the effective region and blocks of the blank region, at least one of the blocks of the blank region being generated from a motion vector of a block of the effective region, and an output control circuit connected to the motion vector search circuit and configured to output the motion vectors of the blocks of the effective region and the blank region that have been generated by the motion vector search circuit in a raster scan order.

Embodiments are described in detail below referring to the drawings.

### First Embodiment

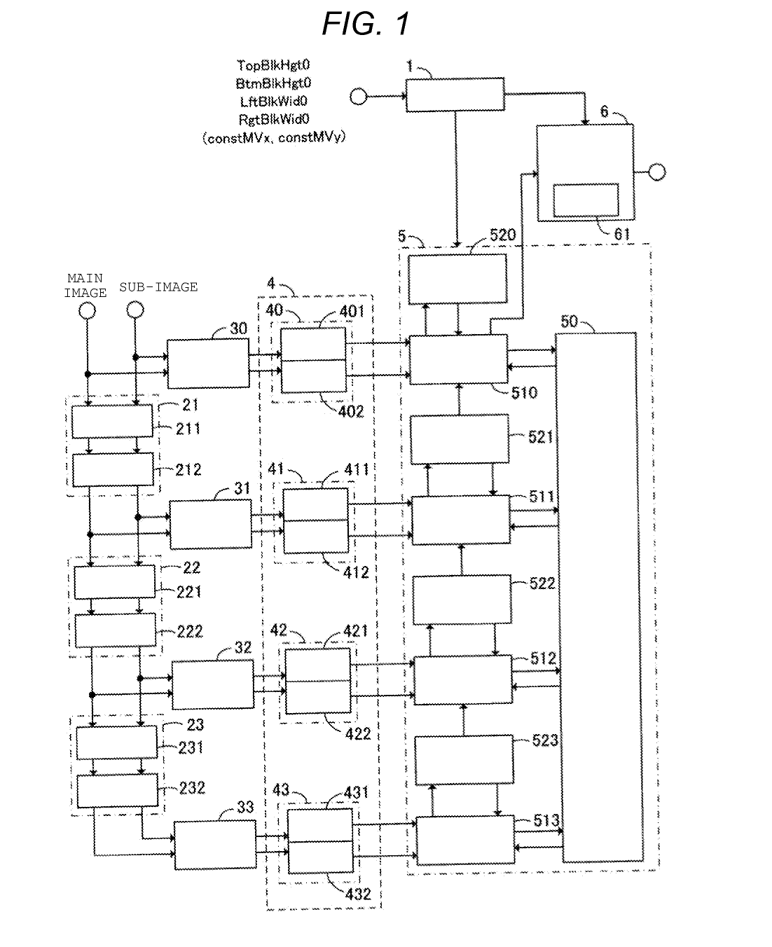

FIG. 1 is a block diagram illustrating a parallax image generation device according to a first embodiment. At least two input images (hereinafter referring to as a main image (second image) and a sub-image (first image)) that are equal to each other in the number of pixels are sent to the parallax image generation device. According to the present embodiment, the main image is configured by only an effective region, and the sub-image is configured by the effective region and blank regions. The blank region is an ineffective region that results from affine processing that is performed in advance, and the like, and that does not include image information. Furthermore, it is assumed that the blank region of the sub-image is known.

According to one embodiment, the parallax image generation device performs filter processing and reduction processing three times and generates pyramid images in a three-tier hierarchical structure that are different from one another in the number of pixels. Then, the parallax image generation device generates the parallax image using the pyramid images. The parallax image refers to a motion vector of each macro block that is set to be within the input image. The motion vector here expresses, in the form of a vector, a relative positional relationship between each macro block within the main (sub) image and a macro block within the sub-(main) image that corresponds to the macro block within the main (sub-) image.

The parallax image generation device may output only the motion vector of the main image, with the sub-image as a reference. Furthermore, the parallax image generation device may output only the motion vector of the sub-image, with the main image as the reference. Alternatively, the parallax image generation device may output the motion vectors of both the main image and the sub-image, each serving as a reference for the other.

Furthermore, an approximately-corresponding macro block is searched for over a wide range using a higher-tier pyramid image that has fewer pixels. Next, a closely-corresponding macro block is searched for using the lower-tier pyramid image that has a greater number of pixels. Thus, the motion vector may be calculated with high precision.

The parallax image generation device in FIG. 1 includes an input interface 1, pyramid image generation units 21 to 23, image writing circuits 30 to 33, a memory 4, a search circuit 5, and an output control circuit 6. The memory 4 includes image memories 40 to 43 that correspond to the image writing circuit 30 to 33 respectively.

Information that defines a range of the blank region in the sub-image and a constant motion vector with which an upper blank region is supplemented are input into the input interface 1.

The pyramid image generation units 21 to 23 reduce the input image or a lower-tier pyramid image and thus generate a higher-tier pyramid image. More specifically, the pyramid image generation unit 21 reduces the main image in the input image. Accordingly, a first-tier pyramid image in the main image that is generated has fewer pixels than the main image. Similarly, the pyramid image generation unit 21 reduces the sub-image in the input image. Accordingly, the first-tier pyramid image in the sub-image that is generated has fewer pixels than the sub-image. The first-tier pyramid images in both cases have an equal number of pixels.

The pyramid image generation unit 22 further reduces the first-tier pyramid images in the main image and the sub-image and thus generates second-tier pyramid images of the main image and the sub-image. The pyramid image generation unit 23 further reduces the second-tier pyramid images in the main image and the sub-image and thus generates third-tier pyramid images of the main image and the sub-image.

The image writing circuit 30 writes the main image and the sub-image to regions 401 and 402 within the image memory 40, respectively. Similarly, the image writing circuit 31 writes the first-tier pyramid images in the main image and the sub-image to regions 411 and 412 within the image memory 41, respectively. The image writing circuit 32 writes the second-tier pyramid images in the main image and the sub-image to regions 421 and 422 within the image memory 42, respectively. The image writing circuit 33 writes the third-tier pyramid images in the main image and the sub-image to regions 431 and 432 within the image memory 43, respectively.

The search circuit 5 searches for the images written to the memories 40 through 43, and generates the motion vector of each macro block within the input image. That is, the search circuit 5 calculates the motion vector of the macro block that is present within an effective region of the input image. Furthermore, the search circuit 5 supplements the motion vector of the macro block that is present within the blank region of the input image, using a copied motion vector or the constant motion vector depending on the particular blank region.

The output control circuit 6 outputs the parallax image of the input image. The output control circuit 6 outputs the calculated motion vector for the macro block that is present within the effective region of the input image. Furthermore, the output control circuit 6 outputs the supplemented motion vector for the macro block that is present within the blank region of the input image.

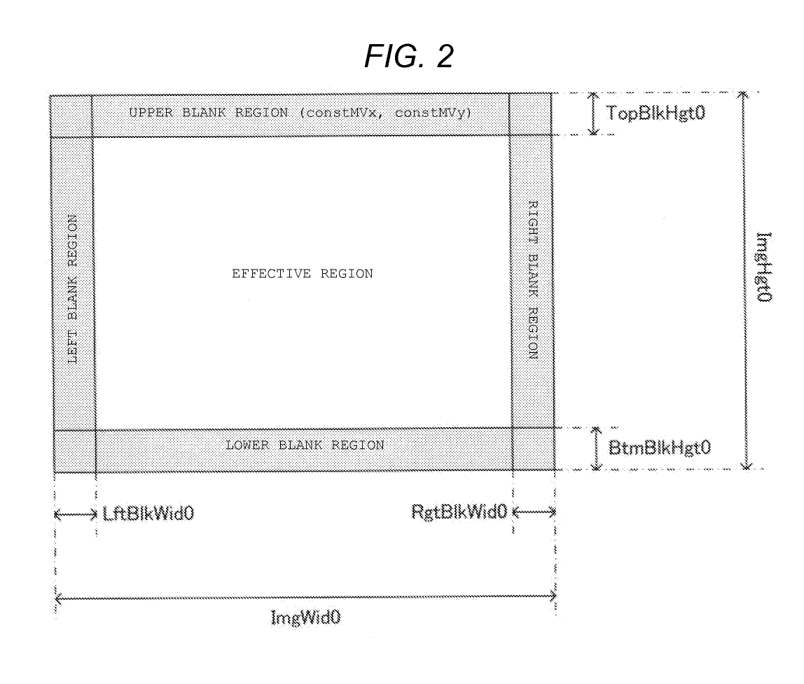

FIG. 2 is a diagram for describing information that is input into the input interface 1. According to the present embodiment, an example is described in which a rectangular upper blank region, a rectangular lower blank region, a rectangular left blank region, and a rectangular right blank region are present in an upper end, a lower end, a left end, and a right end of the sub-image, respectively. Furthermore, the number of pixels in the vertical line and the number of pixels in the horizontal line in the input image are defined as ImgHgt0 and ImgWid0, respectively.

The number TopBlkHgt0 of pixels that is a height of the upper blank region and the number BtmBlkHgt0 of pixels that is a height of the lower blank region, and the number LftBlkWid0 of pixels that is a width of the left blank region and the number RgtBlkWid0 of pixels that is a width of the right blank region are input into the input interface 1. Furthermore, the motion vector (constMVx, constMVy), a fixed value that supplements the upper blank region, is input into the input interface 1.

The pyramid image generation units 21 to 23 are now described. The pyramid image generation unit 21 includes a filter circuit 211 and a reduction circuit 212.

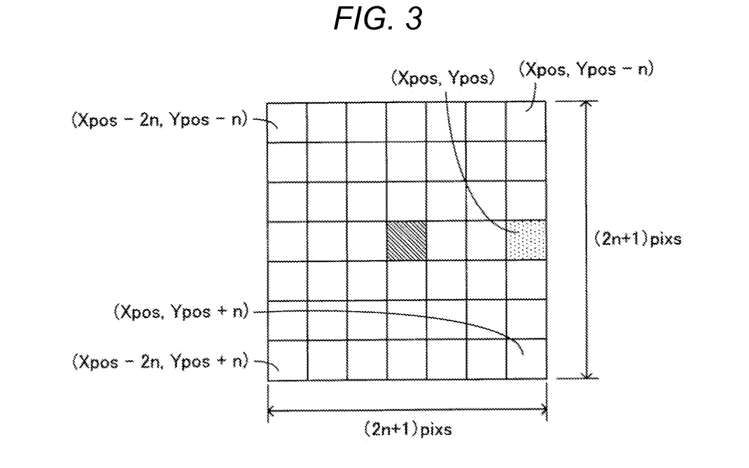

FIG. 3 is a diagram for describing processing by the filter circuit 211. The filter circuit 211 performs filter processing on the input image to smooth the input image. The filter circuit 211 performs the filter processing, such as average filtering or Gaussian filtering, on (2n+1)×(2n+1) pixels in a filter range, where n is an arbitrary integer. Then, the filter circuit 211 outputs a value that is obtained by performing the filter processing on the pixels in the filter range, as a value of a central pixel (pixel marked with oblique lines) of (2n+1)×(2n+1).

As one example, the filter circuit 211 sets the filter range as follows. The filter circuit 211 has counters (not illustrated) inside. For an X coordinate counter, a counter value Xpos of a pixel in a left end of a frame image is set to 0. For a Y coordinate counter, a counter value Ypos of a pixel in an upper end of the frame image is set to 0. The filter circuit 211 may calculate coordinates of each of the pixels in four corners that demarcates a filter range, based on the counter values Xpos and Ypos.

For example, when coordinates of a pixel marked with spots in FIG. 3 are given as (Xpos, Ypos), the filter range is a rectangular region whose four corners are (Xpos−2n, Ypos−n), (Xpos, Ypos−n), (Xpos−2n, Ypos+n), and (Xpos, Ypos+n).

At this point, the filter circuit 211 performs the filter processing only if the filter range does not include the blank region. In other words, if the filter range includes the blank region, the filter circuit 211 does not perform filter processing. The filter circuit 211 does not perform filter processing in order to prevent an ineffective pixel value in the blank region from being reflected in a result of the filtering. That is, if at least one of Equations (1) through (4) is met, the filter circuit 211 does not perform the filter processing.

(Ypos−n)<TopBlkHgt0 (1)

(Ypos+n+1)+BtmBlkHgt0>ImgHgt0 (2)

(Xpos−2n)<LftBlkWid0 (3)

(Xpos+1)+RgtBlkWid0>ImgWid0 (4)

Equations (1) to (4) are equations that determine whether or not each blank region is included in the filter range. Moreover, on the left side of Equations (2) and (4), the “+1” results from the counter values Xpos and Ypos beginning with 0.

The reduction circuit 212 reduces the main image and the sub-image on which such filter processing is performed. A reduction technique is arbitrary, but for example, 2×2 pixels are averaged and thus each of the number of pixels in the vertical line and the number of pixels in horizontal line is reduced to half. Accordingly, the first-tier pyramid image in the main image and the first-tier pyramid image in the sub-image are generated.

The upper blank region TopBlkHgt1, the lower black region BtmBlkHgt1, the left blank region LftBlkWid1, and the right blank region RgtBlkWid1 of the first-tier pyramid image are determined by Equations (5) through (8), respectively.

TopBlkHgt1=(TopBlkHgt0>>1)+(TopBlkHgt & 0×1) (5)

BtmBlkHgt1=(BtmBlkHgt0−1)+(BtmBlkHgt & 0×1) (6)

LftBlkWid1=(LftBlkWid0−1)+(LftBlkWid & 0×1) (7)

RgtBlkWid1=(RgtBlkWid0−1)+(RgtBlkWid & 0×1) (8)

The second term on the right side of each of Equations (5) through (8) is an addition that prevents fractions of the width or height of the blank region from being omitted.

The pyramid image generation units 22 and 23 perform the same processing as the pyramid image generation unit 21, and generate the higher-tier pyramid image from the lower-tier pyramid image as input. The generated first- to third-tier pyramid images are written to the image memories 41 to 43 by the image writing circuits 31 to 33, respectively.

In the case of a reduction ratio described above, a ratio of the number of pixels in the vertical (or horizontal) line in the input image and the number of pixels in the vertical (or horizontal) line in the first-tier pyramid image and the number of pixels in the vertical (or horizontal) line in the second-tier pyramid image and the number of pixels in the vertical (or horizontal) line in the third-tier pyramid image is 8:4:2:1.

The search circuit 5 is now described. The search circuit 5 generates the motion vector of a macro block in a raster scan order. At this point, the search circuit 5 calculates the motion vector of the macro block within the effective region of the sub-image. On the other hand, the search circuit 5 supplements the motion vector of the macro block within the upper blank region of the sub-image using the motion vector (constMVx, constMVy) that is a fixed value that is input into the input interface 1. Furthermore, the search circuit 5 supplements the motion vectors of the macro blocks within the lower, left, and right blank regions of the sub-image, using the motion vectors of the macro blocks that are near or adjacent the target pixel, i.e., at the lower, left, and right ends of the effective region, respectively.

The search circuit 5 in FIG. 1 includes a SAD arithmetic circuit 50, motion vector search circuits 510 to 513, and motion vector memories 520 to 523. The motion vector search circuits 510 to 513 are able to have access to the corresponding image memories 40 to 43 at the same time. The motion vector search circuits 510 to 513 generate the motion vectors of the macro blocks in the input image and the first through third pyramid images, respectively. The motion vector memories 520 to 523 have addresses that correspond to the macro blocks in the input image and the first through third pyramid images, respectively, and the motion vector of the corresponding macro block is written to each address.

At this point, after the generation of all the motion vectors of the third-tier pyramid image is completed, the search circuit 5 starts to generate the motion vectors of the second-tier pyramid image. The same is true also for the first-tier pyramid image and the input image. That is, when generating the motion vectors of the lower-tier pyramid image, it is assumed that the motion vectors of the higher-tier pyramid image are already generated. An example of a more efficient processing technique is described according to a second embodiment.

The motion vector search circuit 513 generates the motion vectors of the macro blocks of the third-tier pyramid image and writes the motion vectors to the motion vector memory 523.

The motion vector search circuit 512 generates the motion vectors of the macro blocks of the second-tier pyramid image by referring to the motion vectors that are written to the motion vector memory 523. Then, the motion vector search circuit 512 writes the generated motion vectors to the motion vector memory 522.

The motion vector search circuit 511 generates the motion vectors of the macro blocks of the first-tier pyramid image by referring to the motion vectors that are written to the motion vector memory 522. Then, the motion vector search circuit 511 writes the generated motion vectors to the motion vector memory 521.

The motion vector search circuit 510 generates the motion vectors of the macro blocks of the input image by referring to the motion vectors that are written to the motion vector memory 521. Then, the motion vector search circuit 510 writes the generated motion vectors to the motion vector memory 520 and outputs the generated motion vectors to the output control circuit 6.

Moreover, it is assumed that the macro blocks that are present in the input image and each pyramid image are the same in size and span m×m pixels (m is an integer).

The generation of the motion vector includes calculating the motion vector of the macro block within the effective region and supplementing the motion vector of the macro block within the blank region. First, the macro block within the effective region is described. The motion vector generating process by the motion vector search circuits 510 and 513 is almost the same. At this point, the motion vector search circuit 510 is described.

The motion vector search circuit 510 performs different processing depending on whether or not the macro block (hereinafter referred to simply as a target macro block) of which the motion vector is a search target is in contact with the blank region. The motion vector search circuit 510 retains macro block counters indicating a position (MBx, MBy) of the macro block inside. For an X coordinate macro block counter, a counter value MBx of the macro block at the left end is set to 0. For a Y coordinate macro block counter, a counter value MBy of the macro block at the upper end is set to 0.

Based on equations (9) and (10) which include the counter values MBx and MBy and the number of pixels in the blank region of the input image, the motion vector search circuit 510 determines whether or not the macro block is in contact with the blank region.

(((MBy−1)<<q)<TopBlkHgt0) and ((MBy<<q)≧TopBlkHgt0) (9)

(((MBx−1)<<q)<LftBlkWid0) and ((MBx<<q)≧LftBlkWid0) (10)

More specifically, equations (9) and (10) are equations for determining whether or not the macro block is in contact with each of the upper and left blank regions. At this point, q is a shift coefficient that depends on the number m of pixels in the vertical and horizontal line in the macro block. For example, if m=2, q=1, and if m=4, q=2, and if m=8, q=3. More generally, if m=2^{p}, then q=p.

Moreover, when generating the motion vector, the motion vector search circuit 510 refers to the motion vectors of the macro blocks that are positioned above and at the left of the target macro block. Because the motion vector search circuit 510 generates the motion vector in the raster scan order, the motion vector search circuit 510 need not determine whether or not the target macro block is in contact with the right and lower blank regions.

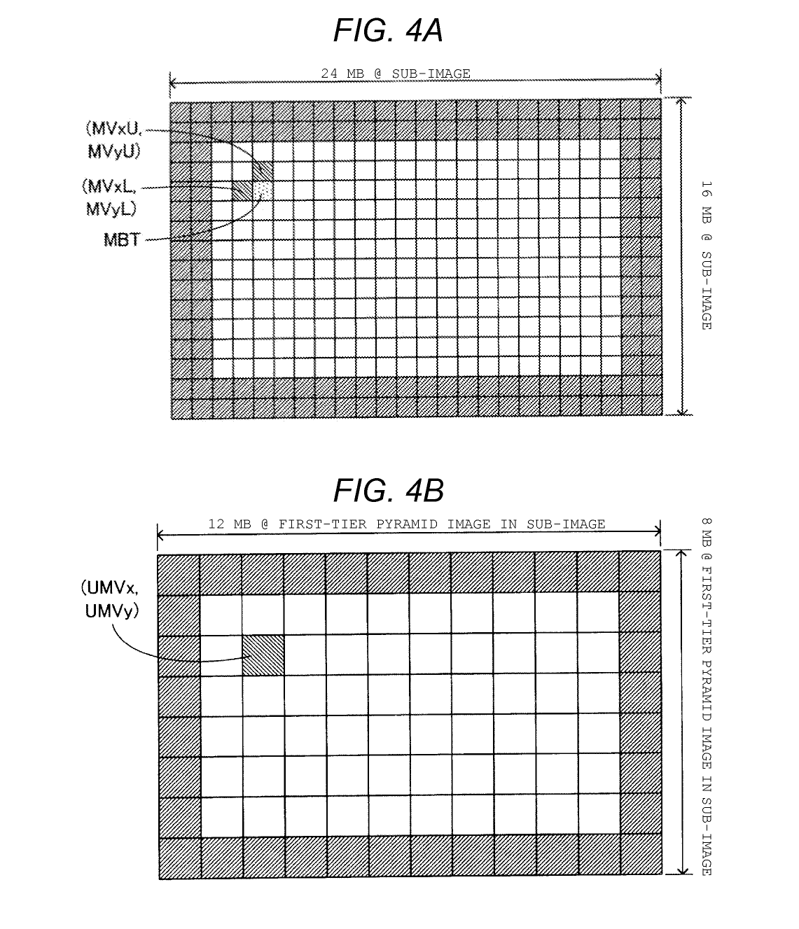

FIGS. 4 to 6 are diagrams for describing in detail a processing operation that is performed by the motion vector search circuit 510 when the macro block is not in contact with a blank region. FIGS. 4 to 6 illustrate states where the motion vector search circuit 510 calculates the motion vector of a target macro block MBT marked with dots in the sub-image (shown as 16×24 macro blocks).

FIGS. 4A and 4B illustrate the motion vectors that are referred to when searching for the motion vector. As illustrated, the motion vector search circuit 510 refers to motion vectors (MVxU, MVyU) and (MVxL, MVyL) of two macro blocks that are positioned above and at the left of the target macro block MBT. The motion vector of the macro block referred to is written to the motion vector memory 520.

Furthermore, the motion vector search circuit 510 refers to a motion vector (UMVx, UMVy) of the macro block corresponding to a position of the target macro block MBT in the first-tier pyramid image in the sub-image (8×12 macro blocks), that is a higher tier. The motion vector (UMVx, UMVy) is also written to the motion vector memory 521. When it is considered that the reduction circuit 212 reduces the input image to half, for example, if macro block coordinates of the target macro block MBT are (4, 4), the macro block coordinates corresponding to the position of the target macro block MBT in the first-tier pyramid image are (2, 2).

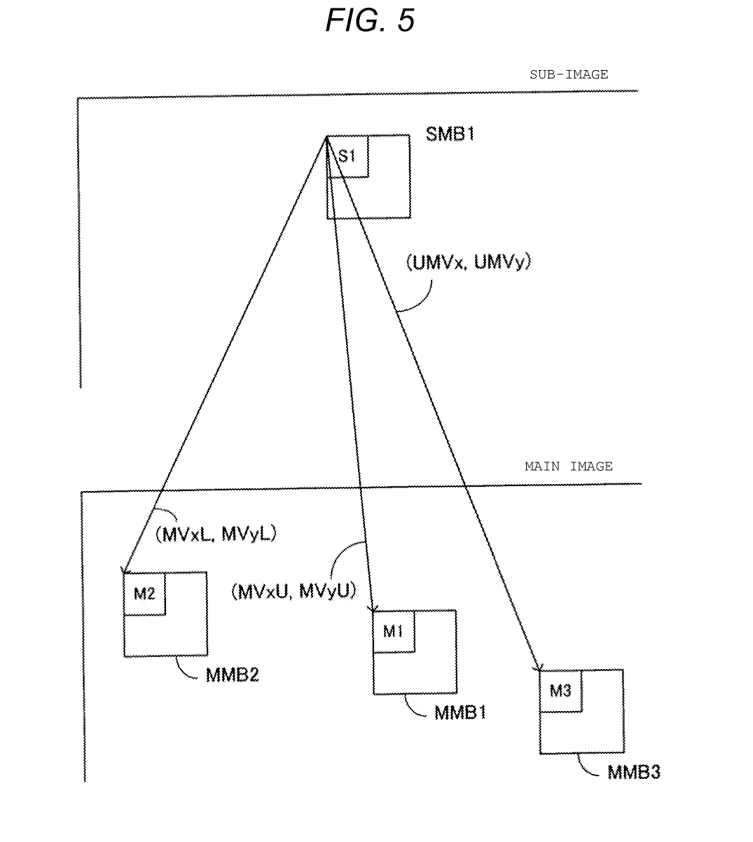

FIG. 5 illustrates a case in which an optimized motion vector candidate is selected from the three motion vectors referred to. A target macro block within the sub-image, for which an upper left pixel has pixel coordinates S1 is defined as a SAD block SMB1. The motion vector search circuit 510 specifies three pixel coordinates M1 to M3 in the main image, based on the motion vectors (MVxU, MVyU), (MVxL, MVyL), and (UMVx, UMVy) referred to, with the pixel coordinates S1 in the sub-image as a starting point. The macro blocks within the main image, whose left pixels are the pixel coordinates M1 to M3, respectively, are defined as SAD blocks MMB1 to MMB3.

At this point, the motion vector search circuit 510 reads pixel values of the SAD blocks MMB1 to MMB3 from the memory 402. The motion vector search circuit 510 also reads a pixel value of the SAD block SMB1 from the memory 401. The pixel value being read is supplied to the SAD arithmetic circuit 50. A SAD block is defined as a block in which the number of pixels is k×k (k is an arbitrary integer). The SAD block may be the same size as the macro block or a different size from the macro block.

Using the supplied pixel value, the SAD arithmetic circuit 50 calculates SAD values (sum of absolute differences) between each of the SAD blocks MMB1 to MMB3 and the SAD block SMB1. Then, among the SAD blocks MMB1 to MMB3, the motion vector search circuit 510 specifies the SAD block whose SAD value is the smallest. Then, the motion vector search circuit 510 sets the vector which has the relative positional relationship between the target macro block and the specified SAD block to be the best motion vector candidate.

In order to simplify the processing, the motion vector search circuit 510 may select the pixel coordinates, from among pixel values of the pixel coordinates M1 to M3, whose difference with the pixel coordinates S1 in the target macro block is the smallest in pixel value, as the best motion vector candidate.

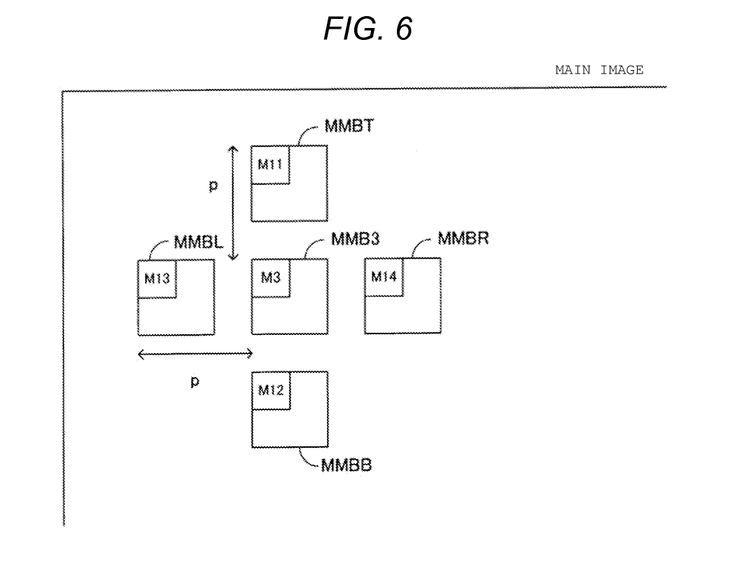

FIG. 6 illustrates a case in which the best motion vector is specified. In FIG. 6, it is assumed that a position of the macro block MMB3 in FIG. 5 is the best motion vector.

As illustrated, the motion vector search circuit 510 considers SAD blocks MMBT, MMBB, MMBL, and MMBR, whose upper left pixels are pixel coordinates M11 to M14, within the main image. The pixel coordinates M11 to M14 are moved only by p pixels in up, down, left, and right directions from the pixel coordinates M3 that is illustrated by the best motion vector candidate.

Then, the SAD arithmetic circuit 50 calculates SAD values of the SAD block (SAD block SMB1 illustrated in FIG. 5) whose upper left pixel is an upper left pixel of the target macro block, and SAD blocks MMB3, MMBT, MMBB, MMBL, and MMBR. Then, the motion vector search circuit 510 specifies the SAD block whose SAD value is the smallest, among the SAD blocks MMB3, MMBT, MMBB, MMBL, and MMBR. Then, the motion vector search circuit 510 writes, to the motion vector memory 520 the vector which has the relative positional relationship between the target macro block and the specified SAD block, as the best motion vector of the target macro block.

To simplify the processing, the motion vector search circuit 510 may specify the pixel coordinates whose difference with respect to the pixel coordinates S1 is the smallest in pixel values, as a best motion vector, among the pixel coordinates M3, M11 to M14 that are determined based on the best motion vector candidates.

As described above, the motion vector search circuit 510 calculates the motion vector in each macro block of the sub-image by referring to the already-calculated motion vector in the sub-image and the motion vector in the corresponding position in the first-tier pyramid image in the sub-image.

In the example, the motion vector search circuit 510 calculates the motion vector based on the SAD value, but the motion vector may be calculated using other arithmetic operations.

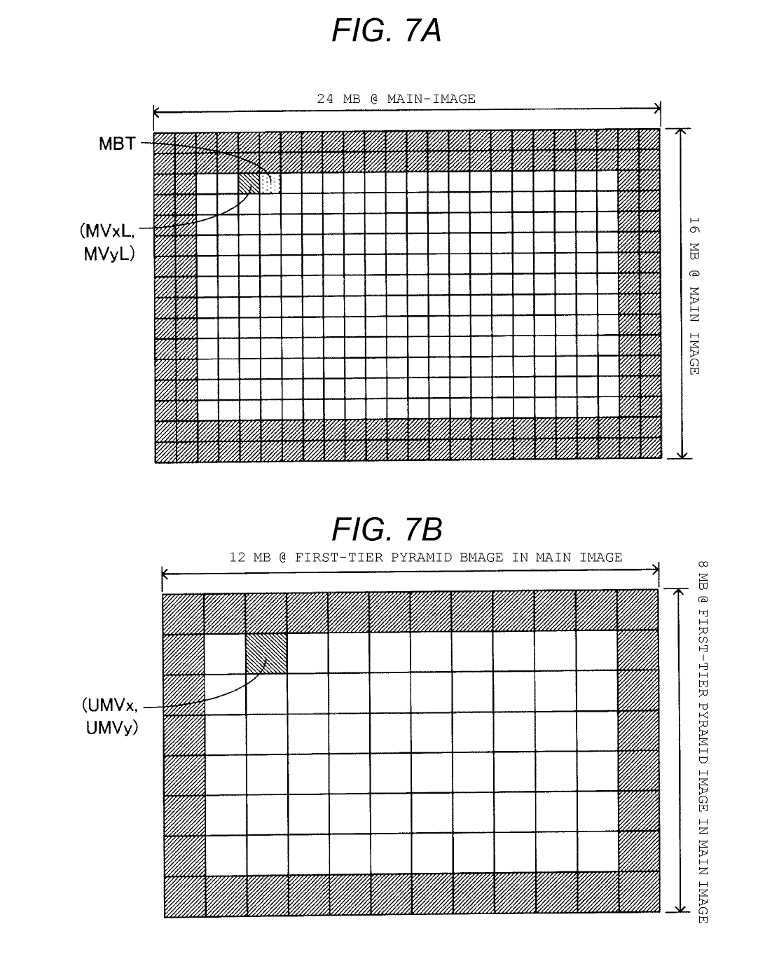

FIGS. 7A and 7B are diagrams for describing processing that is performed by the motion vector search circuit 510 when the target macro block is in contact with a blank region. A description is provided below in terms of what distinguishes FIGS. 7A and 7B from FIGS. 4A and 4B.

In FIGS. 7A and 7B, the target macro block MBT is in contact with the upper blank region. Consequently, the motion vector search circuit 510 does not refer to the motion vector of the macro block within the upper blank region that is positioned over the target macro block MBT. Instead, the motion vector search circuit 510 refers to a motion vector (UMVx, UMVy) of the macro block (macro block marked with oblique lines), to which the target macro block MBT belongs in the first-tier pyramid image, as a replacement motion vector. Then, subsequently, the motion vector search circuit 510 calculates the motion vector of the target macro block, based on two motion vectors (MVxL, MVyL) and (UMVx, UMVy).

In the same manner as the motion vector search circuit 510, the motion vector search circuits 511 and 512 generate the motion vectors in the macro blocks of the first-tier pyramid image and the second-tier pyramid image, respectively. Furthermore, because a high-tier pyramid image is not present, the motion vector search circuit 513 calculates the motion vector in each macro block, by referring to only the already-calculated motion vector in the third-tier pyramid image.

Supplementing the motion vector in the blank region is now described. Supplementing the motion vector is performed when the motion vector search circuits 510 and 513 write the motion vectors to the motion vector memories 520 to 523, respectively. The supplementing of the motion vector by the motion vector search circuit 510 is described below.

The motion vector search circuit 510 writes the calculated motion vector of the macro block within the effective region to an address in the motion vector memory 520 that corresponds to coordinates of the macro block in question. On the other hand, the motion vector search circuit 510 supplements the motion vector of the macro block that is present within the blank region, as described below, and writes the supplemented motion vector to the motion vector memory 520.

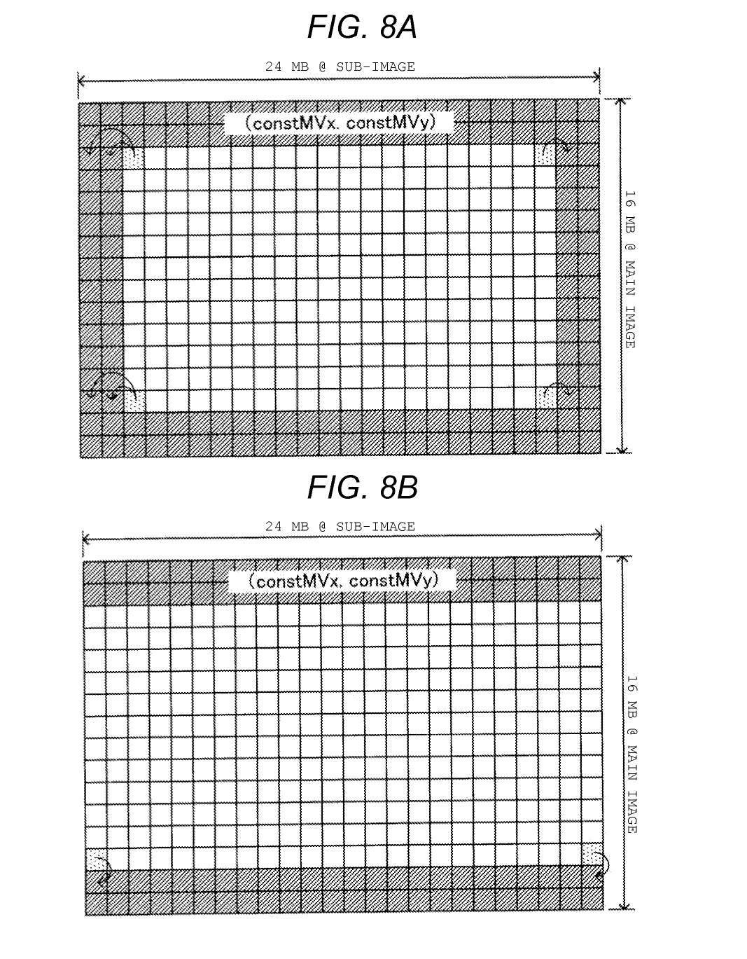

FIGS. 8A and 8B are diagrams for describing in detail a processing operation that is performed by the motion vector search circuit when a target macro block resides in a blank region. FIGS. 8A and 8B additionally are diagrams for describing writing to the motion vector memory 520. Based on the macro block counter, the motion vector search circuit 510 determines whether or not the target macro block to which the motion vector is written is present in the blank region.

If Equation (11) described below is met, the motion vector search circuit 510 determines that the target macro block is present in the upper blank region.

((MBy<<q)<TopBlkHgt0) (11)

The parameter q is the same as in those in Equations (9) and (10) described above. In this case, as illustrated in FIG. 8A, the motion vector search circuit 510 writes a motion vector (constMVx, constMVy), which is a fixed value, to the motion vector memory 520.

If Equation (12) described below is met, the motion vector search circuit 510 determines that the target macro block is present in the left blank region.

((MBx<<q)<LftBlkWid0) (12)

In this case, as illustrated in FIG. 8A, at a point in time at which the motion vector of the macro block that is positioned at the left end of the effective region is calculated, the motion vector search circuit 510 copies the motion vector and thus writes the copied motion vector to the motion vector memory 520.

A more detailed description is now provided. A macro block counter LftBlkMBCnt within the left blank region is provided within the motion vector search circuit 510. When the macro block counter indicates a beginning of a line of macro blocks, the counter LftBlkMBCnt is set to LftBlkMB0. The LftBlkMB0 is the number of the macro blocks that are present in the left blank region.

Thereafter, the motion vector of the macro block that is present in the effective region is calculated, and each time the calculated motion vector is written to an address LftBlkAdr in the motion vector memory 520, which corresponds to the coordinates of the macro block in the left blank region, the motion vector search circuit 510 decrements the counter LftBlkMBCnt by one. After the counter LftBlkMBCnt is decremented down to 0, the motion vector search circuit 510 stops writing to the address LftBlkAdr in the motion vector memory 520.

The number LftBlkMB0 of the macro blocks is expressed in Equation (13) described below.

$$\begin{matrix}Tmp 2 = 0 \times 1 ( when LftBlkWid 0 [ ( q - 1 ) : 0 ] > 0 \times 0 ) \\ = 0 \times 0 ( when the above condition is not met )\end{matrix} \\ LftBlkMB 0 = ( ( LftBlkWid 0 >> q ) + Tmp 2 ) \qquad ( 13 )$$

The address LftBlkAdr is expressed in Equation (14) described below.

LftBlkAdr=address of the front of MB line+(LftBlkMBCnt−0×1) (14)

If Equation (15) described below is met, the motion vector search circuit 510 determines that the target macro block is present in the right blank region.

$$\begin{matrix}Tmp 1 = ImgWid 0 ( when ( ( ( MBx + 1 ) << q ) > ImgWid 0 ) ) \\ = ( ( MBx + 1 ) << q ) ( the above condition is not met )\end{matrix} \\ ( Tmp 1 + RgtBlkWid 0 ) > ImgWid 0 \qquad ( 15 )$$

In this case, as illustrated in FIG. 8A, the motion vector search circuit 510 copies the motion vector of the macro block that is positioned at the left of the target macro block and writes the copied motion vector to the motion vector memory 520. Moreover, because the processing is performed in the raster scan order, even though the target macro block is present within the right blank region, the motion vector of the macro block that is positioned at the left of the target macro block is already confirmed.

If Equation (16) described below is met, the motion vector search circuit 510 determines that the target macro block is present in the lower blank region.

$$\begin{matrix}Tmp 0 = ImgHgt 0 ( when ( ( Mby + 1 ) << q ) > ImgHgt 0 ) \\ = ( ( MBy + 1 ) << q ) ( when the above condition is not met )\end{matrix} \\ ( Tmp 0 + BtmBlkHgt 0 ) > ImgHgt 0 \qquad ( 16 )$$

In this case, in illustrated in FIG. 8B, the motion vector search circuit 510 copies the motion vector of the macro block that is positioned above the target macro block and writes the copied motion vector to the motion vector memory 520. Because the processing is performed in the raster scan order, even though the target macro block is present within the lower blank region, the motion vector of the macro block that is positioned above the target macro block is already known.

As described above, the motion vectors of all the macro blocks are written to the motion vector memory 520. In the same manner, the other motion vector search circuits 511 to 513 also write the generated motion vectors to the motion vector memories 521 to 523, respectively.

Operation of the output control circuit 6 in FIG. 1 is now described. The output control circuit 6 performs output control, based on information that is received by the input interface (IF). The output control circuit 6 has a buffer 61 and the motion vector that is calculated by the search circuit 5 is stored in the buffer 61. The buffer 61 has at least a capacity that is required to store the motion vectors of the macro blocks whose number is obtained at least by “adding 1 to the maximum number of the macro blocks in the left blank region”.

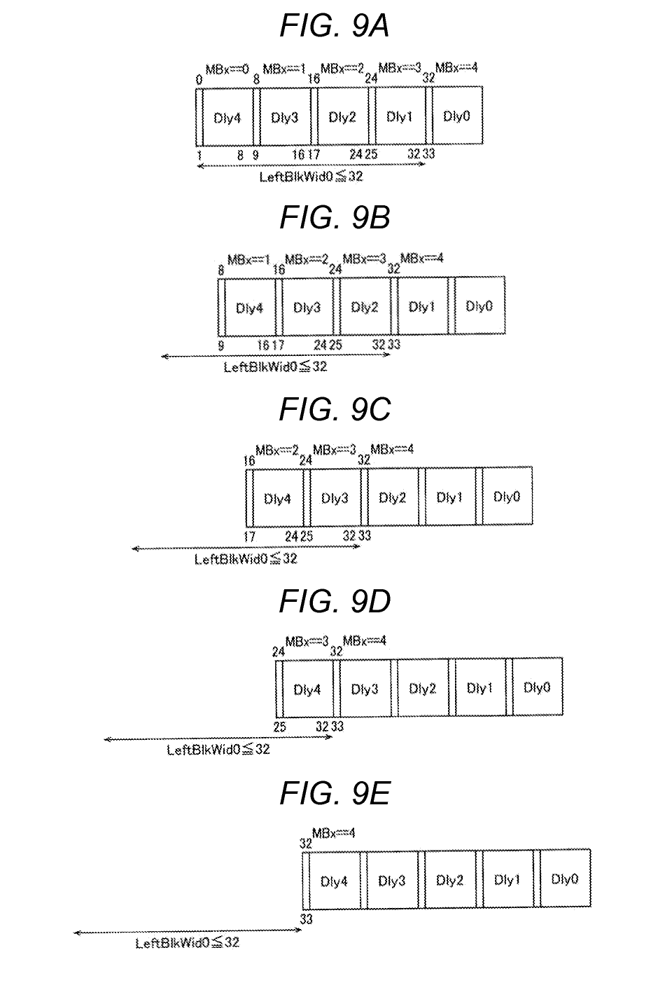

FIGS. 9A to 9E are diagrams illustrating operation of the buffer 61 in which the motion vectors of the macro blocks that are present in the left blank region are stored. FIGS. 9A to 9E illustrate examples in which a width LftBlkWid0 of the left blank region is 32 pixels and the macro block is configured by 8×8 pixels. The output control circuit 6 identifies a width of the left blank region, based on the LftBlkWid0, and performs the output control corresponding to the identified width.

The buffer 61 is a shift register that is configured for five entries Dly0 to Dly4. That is, if the motion vector is output from the search circuit 5, the motion vectors that are stored in the entries Dly0 to Dly3 are shifted to the entries Dly1 to Dly4, respectively, and the motion vector being output is stored in the entry Dly0.

The output control circuit 6 has an output counter that is not illustrated, and sets the output counter in the front of the macro block line to 0. Each time one motion vector is output, the output counter is incremented by one.

The output control circuit 6 has parameters OutSel0 to OutSel4 indicating the storage entry for the motion vector to be sent next. For example, if the parameter OutSel0 is “true”, the output control circuit 6 outputs the motion vector that is stored in the entry Dly0. If the parameter OutSel1 is “true”, the output control circuit 6 outputs the motion vector that is stored in the entry Dly1. The same manner is applied in the other cases. Moreover, among the parameters OutSel0 to OutSel4, two or more parameters do not become “true”.

FIG. 9A illustrates a case in which the output counter indicates 0. At this time, the motion vector of the 0-th macro block (hereinafter expressed as MBx==0) from the left is stored in the entry Dly4. The motion vector of MBx==1 is stored in the entry Dly3. The motion vector of MBx==2 is stored in the entry Dly2. The motion vector of MBx==3 is stored in the entry Dly1. The motion vector of MBx==4 is stored in the entry Dly0. That is, the motion vectors of the macro blocks that are present in the left blank region are stored in the entries Dly1 to Dly4.

If the output counter indicates 0, the output control circuit 6 refers to the width LftBlkWid0 of the left blank region and sets the parameters OutSel0 to OutSel4 as expressed in Equation (17) described below.

$$OutSel 0 = ( LftBlkWid 0 \text{=>} 25 ) \&\& ( LftBlkWid 0 <= 32 ) ; \\ OutSel 1 = ( LftBlkWid 0 \text{=>} 17 ) \&\& ( LftBlkWid 0 <= 24 ) ; \\ OutSel 2 = ( LftBlkWid 0 \text{=>} 9 ) \&\& ( LftBlkWid 0 <= 16 ) ; \\ OutSel 3 = ( LftBlkWid 0 \text{=>} 1 ) \&\& ( LftBlkWid 0 <= 8 ) ; \\ OutSel 4 = ( LftBlkWid 0 == 0 ) ; \qquad ( 17 )$$

The first expression means that if the width LftBlkWid0 of the left blank region is 25 or greater and 32 or less and if the width LftBlkWid0 of the left blank region is 32 pixels, the parameter OutSel0 is set to “true”. Consequently, the output control circuit 6 outputs the motion vector of MBx==4 that is stored in the entry Dly0, as the motion vector of MBx==0. Then, the output control circuit 6 increments the output counter by one. In this manner, the motion vector of the left blank region is replaced with the motion vector of the effective region and thus may be output.

FIG. 9B illustrates a case where the output counter indicates 1. At this time, the motion vector of MBx==1 is stored in the entry Dly4. The motion vector of MBx==2 is stored in the entry Dly3. The motion vector of MBx==3 is stored in the entry Dly2. The motion vector of MBx==4 is stored in the entry Dly1. The motion vector of MBx==5 is stored in the entry Dly0.

If the output counter indicates 1, the output control circuit 6 refers to the width LftBlkWid0 of the left blank region and sets the parameters OutSel0 to OutSel4 as expressed in Equation (18) described below.

$$OutSel 0 = 0 ; \\ OutSel 1 = ( LftBlkWid 0 \text{=>} 25 ) \&\& ( LftBlkWid 0 <= 32 ) ; \\ OutSel 2 = ( LftBlkWid 0 \text{=>} 17 ) \&\& ( LftBlkWid 0 <= 24 ) ; \\ OutSel 3 = ( LftBlkWid 0 \text{=>} 9 ) \&\& ( LftBlkWid 0 <= 16 ) ; \\ OutSel 4 = ( LftBlkWid 0 \text{=>} 0 ) \&\& ( LftBlkWid 0 <= 8 ) ; \qquad ( 18 )$$

FIG. 9C illustrates a case where the output counter indicates 2. In this case, the output control circuit 6 refers to the width LftBlkWid0 of the left blank region and sets the parameters OutSel0 to OutSel4 as expressed in Equation (19) described below.

$$OutSel 0 = 0 ; \\ OutSel 1 = 0 ; \\ OutSel 2 = ( LftBlkWid 0 \text{=>} 25 ) \&\& ( LftBlkWid 0 <= 32 ) ; \\ OutSel 3 = ( LftBlkWid 0 \text{=>} 17 ) \&\& ( LftBlkWid 0 <= 24 ) ; \\ OutSel 4 = ( LftBlkWid 0 \text{=>} 0 ) \&\& ( LftBlkWid 0 <= 16 ) ; \qquad ( 19 )$$

FIG. 9D illustrates a case where the output counter indicates 3. In this case, the output control circuit 6 refers to the width LftBlkWid0 of the left blank region and sets the parameters OutSel0 to OutSel4 as expressed in Equation (20) described below.

$$OutSel 0 = 0 ; \\ OutSel 1 = 0 ; \\ OutSel 2 = 0 ; \\ OutSel 3 = ( LftBlkWid 0 \text{=>} 25 ) \&\& ( LftBlkWid 0 <= 32 ) ; \\ OutSel 4 = ( LftBlkWid 0 \text{=>} 0 ) \&\& ( LftBlkWid 0 <= 24 ) ; \qquad ( 20 )$$

FIG. 9E illustrates a case where the output counter indicates 4 or greater. In this case, the output control circuit 6 refers to the width LftBlkWid0 of the left blank region and sets the parameters OutSel0 to OutSel4 as expressed in Equation (21) described below.

$$OutSel 0 = 0 ; \\ OutSel 1 = 0 ; \\ OutSel 2 = 0 ; \\ OutSel 3 = 0 ; \\ OutSel 4 = ( LftBlkWid 0 \text{=>} 0 ) \&\& ( LftBlkWid 0 <= 32 ) ; \qquad ( 21 )$$

Because the width LftBlkWid0 of the left blank region is maximum 32 pixels, when an output counter value is 4 or greater, the motion vector that is stored in the entry Dly4 is output from the output control circuit 6.

By the processing described above, for the macro block that is present within the left blank region, the motion vector for the effective region is selectively output.

Because the width LftBlkWid0 of the left blank region is maximum 32 pixels, the maximum number of motion vectors that can be stored in the buffer 61 is 5. It should be understood that, when the width LftBlkWid0 of the left blank region is larger than 32 pixels, the size of the buffer 61 is increased so that the maximum number of motion vectors that can be stored in the buffer 61 is greater than 5.

In this manner, according to the first embodiment, the motion vector of the macro block within the blank region is supplemented using the motion vector of the macro block within the effective region. For this reason, even though the blank region is included in the input image, the motion vectors of all the macro blocks may be output.

### Second Embodiment

According to a second embodiment, multiple tier pyramid images are processed in parallel.

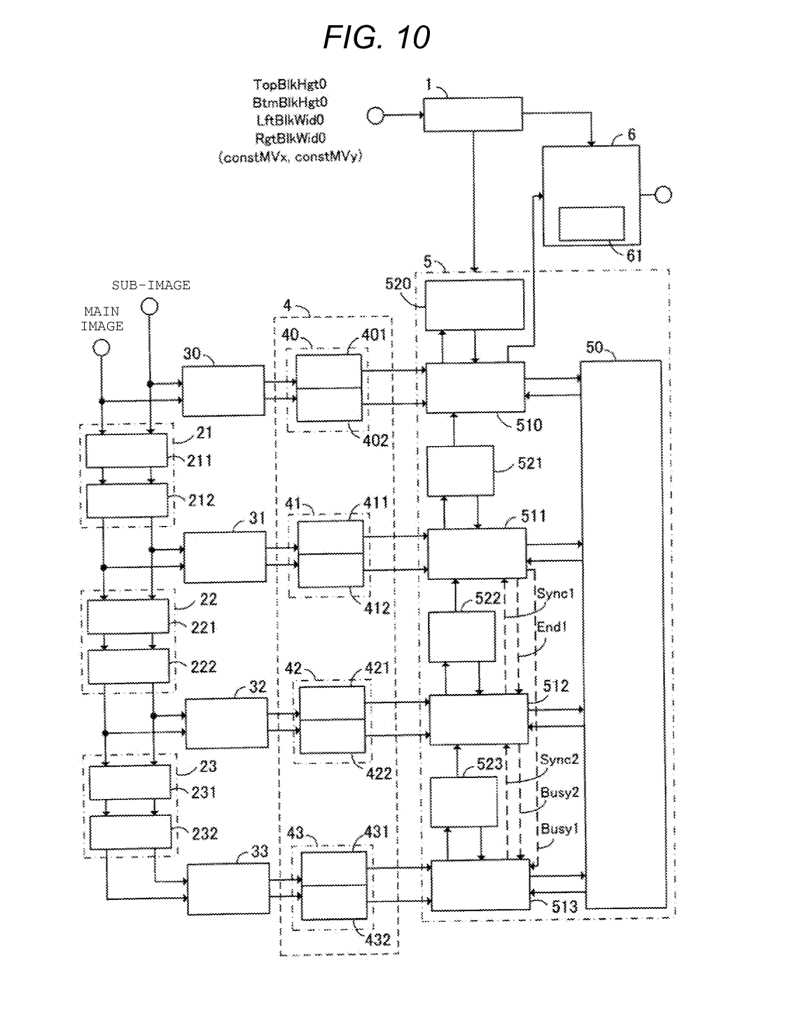

FIG. 10 is a block diagram of a parallax image generation device according to a second embodiment. In FIG. 10, the same reference numerals are assigned to constituent elements that are common to FIGS. 10 and 1. A description is provided below in terms of what distinguishes FIG. 10 from FIG. 1. In FIG. 10, a signal for adjusting processing timing between the motion vector search circuits 511 to 513 is indicated with a broken line.

A signal Sync2 is supplied from the motion vector search circuit 513 to the motion vector search circuit 512. The signal Sync2 indicates that the motion vector search circuit 513 completes processing that generates the motion vectors in one macro block line and instructs the motion vector search circuit 512 to start the processing that generates the motion vectors.

A signal Sync1 is supplied from the motion vector search circuit 512 to the motion vector search circuit 511. The signal Sync1 indicates that the motion vector search circuit 512 completes the processing that generates the motion vectors in one macro block line and instructs the motion vector search circuit 511 to start the processing that generates the motion vectors.

A signal End1 is supplied from the motion vector search circuit 511 to the motion vector search circuit 512.

The signal End1 indicates that the motion vector search circuit 511 completes the processing that generates the motion vector in two macro block lines.

Signals Busy1 and Busy2 are supplied from the motion vector search circuits 511 and 512, respectively, back to the motion vector search circuit 513. The signals Busy1 and Busy 2 indicate that the motion vector search circuits 511 and 512 are generating the motion vectors, respectively.

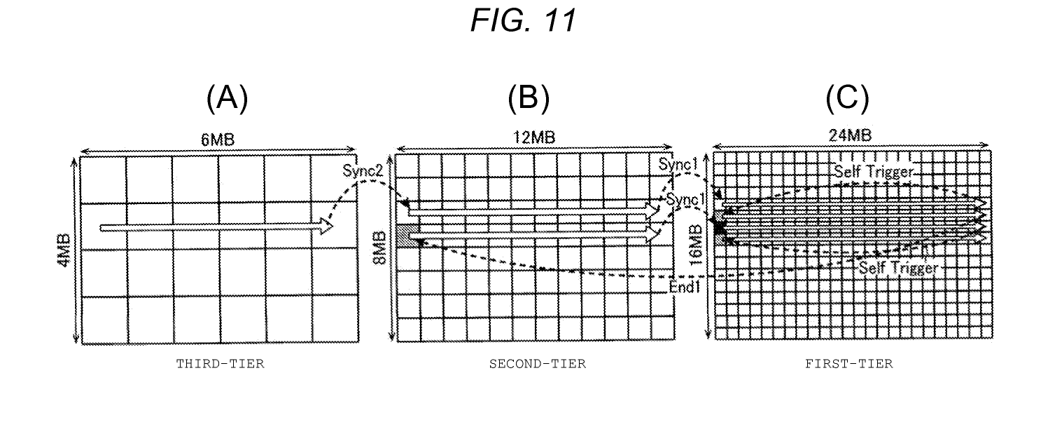

FIGS. 11(A) through 11(C) are diagrams for describing timing of processing by the parallax image generation device in FIG. 10. First, the motion vector search circuit 513 generates the motion vectors in a line of macro blocks in the third-tier pyramid image and writes the generated motion vectors into the motion vector memory 523. When the processing that generates the motion vector is completed, the signal Sync2 notifies the motion vector search circuit 512 that the processing that generates the motion vectors is completed.

The motion vector search circuit 512 is synchronized by such notification, and thus starts to generate the motion vectors in a line of macro blocks in the second-tier pyramid image and writes the generated motion vectors into the motion vector memory 522. Furthermore, with the assertion by the signal Busy2, the motion vector search circuit 513 is notified that the motion vector search circuit 512 is performing the processing.

A particular macro block line that is a processing target in the second-tier pyramid image corresponds to a position of a particular macro block line in the third-tier pyramid image in which the motion vector is previously generated. Consequently, the motion vector search circuit 512 may refer to the motion vectors of the third-tier pyramid image that are written to the motion vector memory 523. When the motion vector search circuit 512 completes the processing that generates the motion vectors in a particular macro block line, the signal Sync1 notifies the motion vector search circuit 511 that the processing that generates the motion vectors is completed.

The motion vector search circuit 511 is synchronized with this notification, and thus starts to generate the motion vectors in a particular macro block line in the first-tier pyramid image and writes the generated motion vectors into the motion vector memory 521. Furthermore, by asserting the signal Busy 1, the motion vector search circuit 513 is notified that the motion vector search circuit 511 is performing the processing.

A particular macro block line that is a processing target in the first-tier pyramid image corresponds to a position of one macro block line in which the motion vector is previously generated in the second-tier pyramid image. Consequently, the motion vector search circuit 511 may refer to the motion vectors of the second-tier pyramid image that are written into the motion vector memory 522.

When completing the processing that generates the motion vectors in a particular macro block line, with a self-trigger, the motion vector search circuit 511 starts to generate the motion vectors in a next macro block line. When the motion vector search circuit 511 completes the processing that generates the motion vectors in the next macro block line, the signal End1 notifies the motion vector search circuit 512 that the processing that generates the motion vectors is completed.

The motion vector search circuit 512 is synchronized by this notification, and thus starts to generate the motion vectors in the next one macro block line. When the motion vector search circuit 512 completes the processing that generates the motion vectors in the next one macro block line, the signal Sync1 notifies the motion vector search circuit 511 that the processing that generates the motion vectors is completed. The motion vector search circuit 511 is synchronized with this notification, and thus starts to generate the motion vectors in a next one macro block line.

When the processing of the motion vectors in the four macro block lines of the first-tier pyramid image is completed, the signals Busy1 and Busy2 are de-asserted. Accordingly, the motion vector search circuit 513 determines that a processing sequence is completed in the motion vector search circuits 511 and 512. The motion vector search circuit 513 is synchronized with the completion and thus starts to generate the motion vectors in a next one macro block line.

After all the motion vectors of the first- to third-tier pyramid images are generated by performing the processing in this manner, the motion vector search circuit 510 generates the motion vector of the input image.

In this manner, according to the second embodiment, the motion vector search circuits 511 and 513 cooperate with each other and generate the motion vector in parallel. For this reason, the parallax image may be generated more efficiently and more quickly.

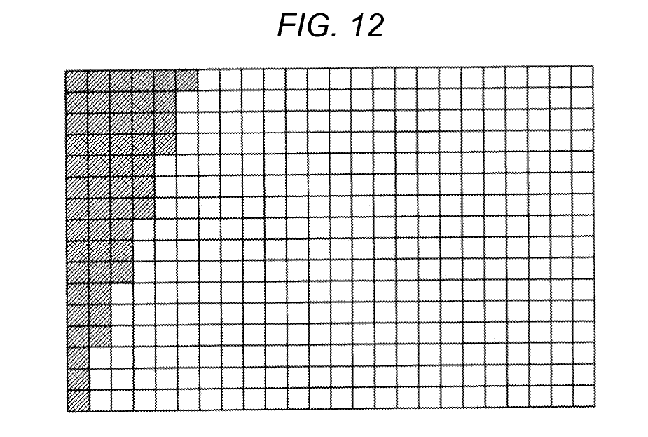

According to the first and second embodiments, the example in which the blank region is in the shape of a rectangle is illustrated. However, as illustrated in FIG. 12, it is possible that the blank region is oblique in the sub-image. In such a case, information on an inclination and a segment of the blank region may be input into the input interface 1.

Furthermore, according to the first and second embodiments, the example in which the main image is configured by only the effective region and the sub-image is configured by the effective region and the blank regions is illustrated. However, both of the main image and the sub-image may be configured by the effective region and the blank regions. Also in this case, the parallax image generation device may generate the motion vector to the main image, which uses the sub-image as the reference, and the motion vector to the sub-image, which uses the main image as the reference.

That is, the search circuit 5 may calculate the motion vector of each macro block that is set to be in the effective region of the main image, and may supplement the motion vector of each macro block that is set to be in the blank region of the main image. Then, the output control circuit 6 may output the calculated motion vector for each macro block that is set to be in the effective region of the main image, and may output the supplemented motion vector for each macro block that is set to be in the blank region of the main image.

Furthermore, according to the first and second embodiments, the example in which the number of the tier pyramid images is 3 is illustrated. However, the number of the tier pyramid images may be any integer. In this case, circuits necessary for processing each tier pyramid image may be configured such as a pyramid image generation unit or an image writing circuit.

At least one or more of the parallax image generation devices that are described according to the embodiments may be configured in software and may be configured in hardware. In a case of the software implementation configuration, a program for realizing at least one or more functions of the parallax image generation device may be stored in a recording medium, such as a flexible disk or a CD-ROM and may be executed by causing a computer to read the program. The recording medium is not limited to a mountable and removable recording medium such as a magnetic or optical disk, and may be a fixed-type recording medium such as a hard disk drive or a memory.

Furthermore, the programs for realizing at least one or more functions of the parallax image generation device may be distributed through a communication line (including wireless communication) such as the Internet. Besides, in a coded, modulated, or compressed state, the program may be distributed through a wire or wireless line such as the Internet or may be stored in the recording medium and thus be distributed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A parallax image generation device for generating motion vectors of a first image with respect to a second image, the first image including a blank region that does not contain any image information and an effective region that contains image information, the device comprising:
a motion vector search circuit configured to generate motion vectors of blocks of the effective region and blocks of the blank region, at least one of the blocks of the blank region being generated from a motion vector of a block of the effective region; and
an output control circuit connected to the motion vector search circuit and configured to output the motion vectors of the blocks of the effective region and the blank region that have been generated by the motion vector search circuit in a raster scan order.

2. The device according to claim 1,
wherein the blank region includes
an upper blank region that is present at an upper end of the first image,
a lower blank region that is present at a lower end of the first image,
a left blank region that is present at a left end of the first image, and
a right blank region that is present at a right end of the first image, and
wherein the output control circuit is configured to output the motion vectors of the blocks of the effective region and blocks of the blank region in the raster scan order, such that the motion vectors of the blocks of the upper blank region are output before the motion vectors of the blocks of the effective region and the motion vectors of the blocks of the effective region are output before the motion vectors of the blocks of the lower blank region, and, within a given raster scan line including the effective region, the motion vectors of the blocks of the left blank region, the effective region, and the right blank region, are output in that order.

3. The device according to claim 2, wherein the motion vector search circuit is configured to set a fixed value to the motion vectors of the blocks of the upper blank region, and set a motion vector of a block of the lower blank region to be equal to the motion vector of the block of the effective region that is adjacent thereto.

4. The device according to claim 3, wherein the output control circuit includes a buffer that stores the motion vectors generated by the motion vector search circuit, the maximum number of motion vectors that can be stored in the buffer at any one time is proportional to a size of the left blank region.

5. The device according to claim 4, wherein, for a given raster scan line including the effective region, the output control circuit is configured to output a motion vector of the block of the effective region that is adjacent to the left blank region as the motion vector of the block of the left blank region.

6. The device according to claim 1, further comprising:
a pyramid image generation circuit configured to reduce the first image and the second image to generate a first pyramid image and a second pyramid image, respectively,
wherein the motion vector search circuit includes
a first motion vector search circuit configured to generate motion vectors of the first pyramid image with respect to the second pyramid image, and
a second motion vector search circuit configured to generate the motion vectors of the blocks of the first image, the motion vectors of the blocks of the first image being generated based on the motion vectors generated by the first motion vector search circuit.

7. The device according to claim 6, wherein
the first motion vector search circuit is configured to divide the first pyramid image into a plurality of processing blocks, each of which is associated with multiple blocks of the first image, and generate a motion vector for each of the processing blocks, and
the second motion vector search circuit is configured to generate a motion vector of a block of the first image based on the motion vector of the processing block associated therewith.

8. A parallax image generation device for generating motion vectors of a first image with respect to a second image, the first image including a blank region that does not contain any image information and an effective region that contains image information, the device comprising:
a pyramid image generation circuit configured to reduce the first image and the second image to generate a first pyramid image and a second pyramid image, respectively;
a first motion vector search circuit configured to generate motion vectors of the first pyramid image with respect to the second pyramid image, and
a second motion vector search circuit configured to generate the motion vectors of the first image with respect to the second image in a raster scan order, based on the motion vectors generated by the first motion vector search circuit and the motion vectors previously by the second motion vector search circuit; and
an output control circuit connected to the second motion vector search circuit and configured to output the motion vectors of the first image with respect to the second image including the motion vectors for both the blank region and the effective region of the first image.

9. The device according to claim 8,
wherein the blank region includes
an upper blank region that is present at an upper end of the first image,
a lower blank region that is present at a lower end of the first image,
a left blank region that is present at a left end of the first image, and
a right blank region that is present at a right end of the first image, and
wherein the output control circuit is configured to output the motion vectors of the first image with respect to the second image, such that the motion vectors of the upper blank region are output before the motion vectors of the effective region and the motion vectors of the effective region are output before the motion vectors of the lower blank region, and, within a given raster scan line including the effective region, the motion vectors of the left blank region, the effective region, and the right blank region, are output in that order.

10. The device according to claim 9, wherein the second motion vector search circuit is configured to set a fixed value to the motion vectors of the upper blank region, and set each of the motion vectors of the lower blank region to be equal to one of the motion vectors of the effective region.

11. The device according to claim 10, wherein the output control circuit includes a buffer that stores the motion vectors generated by the second motion vector search circuit, the maximum number of motion vectors that can be stored in the buffer at any one time is proportional to a size of the left blank region.

12. The device according to claim 11, wherein, for a given raster scan line including the effective region, the output control circuit is configured to output a motion vector of the effective region as the motion vector of the left blank region.

13. The device according to claim 8, wherein
the first motion vector search circuit is configured to divide the first pyramid image into a plurality of first macro blocks and to generate a motion vector for each of the first macro blocks, and the second motion vector search circuit is configured to divide the first image into a plurality of second macro blocks and to generate a motion vector for each of the second macro blocks, and
each of the first macro blocks is associated with multiple second macro blocks, and the first motion vector search circuit is configured to generate a motion vector of a second macro block based on the motion vector of the first macro block associated therewith.

14. A parallax image generation method for generating motion vectors of a first image with respect to a second image, the first image including a blank region that does not contain any image information and an effective region that contains image information, the method comprising:
generating motion vectors of blocks of the effective region and blocks of the blank region, at least one of the blocks of the blank region being generated from a motion vector of a block of the effective region; and
outputting the motion vectors of the blocks of the effective region and the blank region that have been generated by the motion vector search circuit in a raster scan order.

15. The method according to claim 14,
wherein the blank region includes
an upper blank region that is present at an upper end of the first image,
a lower blank region that is present at a lower end of the first image,
a left blank region that is present at a left end of the first image, and
a right blank region that is present at a right end of the first image, and
wherein the motion vectors of the blocks of the upper blank region are output before the motion vectors of the blocks of the effective region and the motion vectors of the blocks of the effective region are output before the motion vectors of the blocks of the lower blank region, and, within a given raster scan line including the effective region, the motion vectors of the blocks of the left blank region, the effective region, and the right blank region, are output in that order.

16. The method according to claim 15, wherein said generating includes:
setting a fixed value to the motion vectors of the blocks of the upper blank region; and
setting a motion vector of a block of the lower blank region to be equal to the motion vector of the block of the effective region that is adjacent thereto.

17. The method according to claim 16, further comprising:
prior to said outputting, storing the motion vectors generated by the motion vector search circuit in a buffer,
wherein the maximum number of motion vectors that can be stored in the buffer at any one time is proportional to a size of the left blank region.

18. The method according to claim 17, wherein, for a given raster scan line including the effective region, a motion vector of the block of the effective region that is adjacent to the left blank region is output as the motion vector of the block of the left blank region.

19. The method according to claim 14, further comprising:
reducing the first image and the second image to generate a first pyramid image and a second pyramid image, respectively; and
generating motion vectors of the first pyramid image with respect to the second pyramid image,
wherein the motion vectors of the blocks of the first image are generated based on the motion vectors of the first pyramid image generated with respect to the second pyramid image.

20. The method according to claim 19, further comprising:
dividing the first pyramid image into a plurality of processing blocks, each of which is associated with multiple blocks of the first image, and generating a motion vector for each of the processing blocks,
wherein a motion vector of a block of the first image is generated based on the motion vector of the processing block associated therewith.
